(19) United States
(12) Patent Application Publication
(10) Pub. No.: US 2025/0307841 A1
(43) Pub. Date: Oct. 2, 2025

(54) INTELLIGENT EMISSION FACTOR MAPPING

(71) Applicant: SAP SE, Walldorf (DE)

(72) Inventors: Max Lenk, Leimen (DE); Anna-Maria Berezovski, Mannheim (DE); Nico Wottke, Mannheim (DE)

(21) Appl. No.: 18/653,206

(22) Filed: May 2, 2024

Related U.S. Application Data
(60) Provisional application No. 63/571,374, filed on Mar. 28, 2024.

(51) Int. Cl. G06Q 10/0637; G06F 3/0482; G06F 40/30

(52) U.S. Cl. CPC G06Q 30/018; G06F 3/0482; G06F 40/30

(57) ABSTRACT

In some implementations, there is a method including searching a plurality of word embeddings representative of a plurality of materials each mapped to a corresponding emission factor by comparing the at least one word embedding representative of the at least one material to at least a portion of the plurality of word embeddings. Related systems, methods, and articles of manufacture are also disclosed.

### CROSS-REFERENCE TO RELATED APPLICATIONS

The present application claims priority to U.S. Provisional Application No. 63/571,374, filed Mar. 28, 2024, and entitled “INTELLIGENT EMISSION FACTOR MAPPING,” and incorporates its disclosure herein by reference in its entirety.

### BACKGROUND

To determine a carbon footprint (or other types of impact, such as land or water use, and/or the like) for an item, such a product that is being used or acquired by an entity such as a user or a company, the emission factor for each of the materials of the item is used. The phrase “emission factor” refers to a value, such as a coefficient, that can be used to determine greenhouse gas emissions. The emission factor for a given material may take into account for example production of a material, transport of the material, disposal of the material, and/or the like. Often, one or more third party databases must be searched to identify an emission factor for a given material, and if an emission factor is identified, the emission factor is manually mapped to the material.

### SUMMARY

Systems, methods, and articles of manufacture, including computer program products, are provided for intelligent emission factor mapping. In some embodiments, there may be provided a system that includes at least one processor and at least one memory including program code which when executed by the at least one processor causes operations including receiving, from a user interface, a request including at least one material for which an emission factor suggestion is requested; providing the at least one material to a language model; in response to the providing, receiving, from the language model, at least one word embedding representative of the at least one material; searching a plurality of word embeddings representative of a plurality of materials each mapped to a corresponding emission factor, the searching comprising comparing the at least one word embedding representative of the at least one material to at least a portion of the plurality of word embeddings; identifying, based on a similarity metric, at least one matching word embedding for the at least one word embedding representative of the at least one material, wherein the at least one matching word embedding maps to at least one emission factor; and sending, to the user interface, a response including the at least one emission factor and a corresponding confidence score based on the similarity metric to indicate a similarity between the at least one word embedding and the at least one matching word embedding.

In some variations, one or more features disclosed herein can optionally be included in any feasible combination. The request may be received with one or more additional attributes associated with the at least one material. The additional attributes comprise a commodity code, a product group, a supplier, a country, and/or a region. The providing further includes providing the at least one material and the one or more additional attributes to the language model. In response to the providing, the receiving, from the language model, further includes receiving at least one word embedding representative of the at least one material and the one or more additional attributes. The comparing includes comparing the at least one word embedding representative of the at least one material and the one or more additional attributes to the plurality of word embeddings. The searching of the plurality of word embeddings further includes limiting the searching to only the plurality of word embeddings having a same commodity code as the at least one material. The identifying further includes filtering the at least one matching word embedding based on geography and/or a validity period. The similarity metric includes a cosine similarity metric determined between the at least one word embedding representative of the at least one material and the plurality of word embeddings. The searching includes searching a vector database containing the plurality of word embeddings representative of the plurality of materials. The at least one emission factor is stored such that the at least one emission factor is mapped to the at least one matching word embedding. The confidence score includes a sum of a cosine similarity score, a geography score, a commodity code score, and a temporal score.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for intelligent emission factor mapping, in accordance with some embodiments;

FIG. 2 depicts an example of a process for obtaining emission factors for materials, in accordance with some embodiments;

FIGS. 3, 4, 5, 6, 7, and 8 depict examples of user interfaces used in the process of obtaining emission factors, in accordance with some embodiments;

FIG. 9 depicts another example of a process for searching for emission factors, in accordance with some embodiments;

FIG. 10 depicts another example of a process for obtaining emission factors, in accordance with some embodiments; and

FIG. 11 depicts a block diagram illustrating a computing system, in accordance with some example embodiments.

When practical, similar reference numbers denote similar structures, features, or elements.

### DETAILED DESCRIPTION

To determine a carbon footprint for an item, a system, such as an enterprise resource planning (ERP) system, may include data for materials (“material data”) that is used in the creation of the item. The material data may need to be mapped against one or more emission factors. For example, the item may correspond to a cake, in which case the material data may include material data related to ingredients, such as butter, milk, eggs, and cream. In this example, the butter, milk, eggs, and cream would each need to be mapped to a corresponding emission factor. However, searching for emission factors in third party databases using this material data (e.g., butter, milk, eggs, and cream) is prune to errors due in part to the complexity of the search. For example, the emission factor for butter may have an emission factor that depends on various factors, such as geography, source, time period, and/or the like.

In some embodiments, there is provided an automated process for mapping materials (e.g., associated with at least one product) to corresponding emission factors by automatically providing intelligent suggestions for the materials. In some embodiments, the intelligent suggestions may be generated based on at least a semantic search using word embeddings (or “embeddings” for short).

For each emission factor for example, a document may be created. This document may include some (if not all of) the natural language information about the material. This material information in the document may then be used to create one or more word embeddings. These one or more word embeddings (which are mapped to a corresponding emission factor for the material) may be stored in an embeddings store, such as a database, vector database, and/or the like. In the case of “butter” for example, the word “butter” may be represented using a word embedding and the word embedding is then mapped (e.g., linked) to the emission factor for “butter”, which can then be stored (e.g., in a database, a vector database, or some other type of storage) so the embedding can later be searched.

When a user requests an intelligent suggestion for a material, a word embedding is created using the material information. If for example, the user is searching for an emission factor for “butter”, the material information (e.g., “butter”) is used to form a word embedding. The word embedding for “butter” is used to search through the stored word embeddings (which have been mapped to emission factors). If the word embedding for “butter” is within a threshold distance (or some other similarity metric) of any of the stored word embeddings, the corresponding word embeddings are considered a match, such that the corresponding mapped emission factors are used as suggested emission factors for the initial request. After the suggestions are generated, a user may review the suggestion(s), select a best fitting emission factor(s), and finally approve the emission factor for use as the emission factor for the material when determining the carbon footprint. To compare the suggestions, the system may provide a confidence score of the mapping that will indicate why proposed emission factor is a good fit for the material being searched for, and based on the confidence score, the user may choose to a suggested emission factor or select another one.

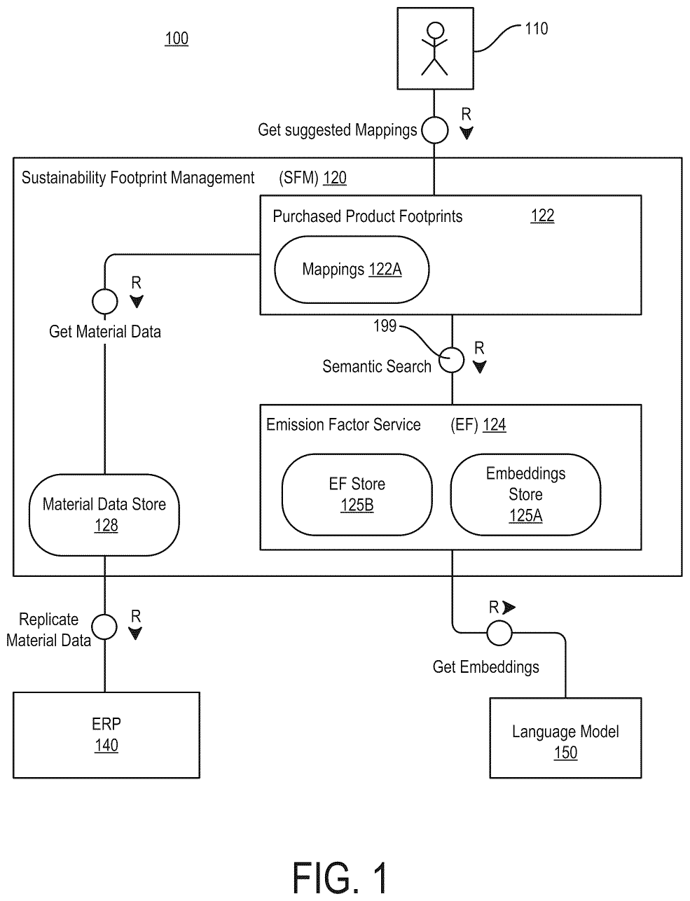

FIG. 1 depicts an example of a system 100 for intelligent emission factor mapping, in accordance with some embodiments.

The system 100 may include a client device 110 at which a user can access the system 100. The client device may comprise a user equipment (e.g., a computer, a smart phone, a tablet, an IoT device) with applications, such as an operating system, a browser, and/or other applications.

The system 100 may include a sustainability footprint management (SFM 120) system. The SFM may be comprised as a service (which may be on-premises, on a cloud platform, and/or a combination of the two), and may be accessed via a network by one or more client devices, such as the client device 110.

The SFM 120 may couple to other systems, such as an ERP system 140 or other types of systems or databases. In the example of FIG. 1, the SFM 120 couples to the ERP system 140 to obtain material data for one or more products. Referring to the cake example above, the ERP system (which e.g., does enterprise resource planning for the cake) may obtain a listing of all the materials for the cake product and replicate the material data in material data store 128.

The SFM 120 may include, or have access to, the material data store 128, a purchased product footprint (PPF 122) service, and an emission factor (EF 124) service.

The material data store 128 may, as noted, be used to store a replica of material data for one or more products. For example, the ERP system 140 may be used for resource planning of a product, such as cake. In this example, the ERP system 140 may include material data for the cake product, such as material information related to the materials used to create the cake (e.g., butter, milk, eggs, cream, etc.).

The PPF 122 service may determine emission factors (and/or determine carbon footprints based on the emission factors). For example, the PPF may (1) provide a worklist for the user containing materials that need to be mapped to carbon footprints, (2) trigger an intelligent mapping process to map at least one material to at least one emission factor, (3) present suggested mappings to user via a presentation at a display at the client device 110, (4) enable the review and approval of suggested mappings, and/or (5) display the confidence score(s).

The EF 124 may include one or more word embeddings (or “embedding” for short) and one or more emission factors. For example, the EF service may include an embeddings store 125A which includes one or more emission factors that may be obtained (e.g., loaded) from other databases, such as third-party databases storing emission factors for materials. For example, the EF service may handle the upload from third-party databases containing emission factors and may store the emission factors in the emission factors store 125B. This upload from third-party database(s) allows the system 100 to map the emission factors to word embedding, so that a search by the client 110 finds the emission factors more accurately and quickly (e.g., with repeated and/or inaccurate search results), when compared to the enable the client 100 attempting to directly search third-party websites for emission factors.

In some embodiments, the EF 124 may cause (e.g., trigger) creation of embeddings for the emission factors. For example, the EF 124 may get embedding for emission factors by using a machine learning model, such as a language model 150 (LM). For example, the emission factor for butter may be obtained by sending the string “butter” to the language model 150. In this example, the language model returns a representation of “butter”, and this representation may be in the form of a vector, such as a numerical value (e.g., a real number). This representation in the form of a real number, for example, may then be used as an embedding. In the case of natural language processing, the word embedding encodes a word such that similar words (having a similar meaning, for example) are closer to each other in vector space. The returned embedding for “butter” in this example may be mapped to the emission factor, so that a search in vector space for butter identifies not only the embedding for “butter” but also the mapped emission factor. In some embodiments, the returned embedding(s) (which are mapped to emission factors) are stored (e.g., in a database, such as a vector database).

In some embodiments, the EF 124 may also provide a semantic search API 199. The semantic search API enables searching based on the embeddings (e.g., comparing embeddings) and selecting matches based on a threshold distance or similarity metric, such as a cosine similarity metric.

To illustrate by way of an example, a user at a client device 110 may access intelligent emission factor mapping data (“Mapping” 122A) via an application, such as the PPF 122. The user at the client device 110 may view a list of one or more materials (e.g., materials for a product) that have been mapped to an emission factor. Moreover, the user at the client device 110 may view a list of one or more materials (e.g., materials for a product) that have not yet been mapped to an emission factor, and then the user may select one or more materials for the intelligent emission factor search. Based on a selected material, a search query is sent from the client device 110 to the EF 124 service. The EF 124 service may manage the emission factors that are available for mapping. Moreover, the emission factors may then be uploaded and stored at the emission factors store 125B. Once the upload of the emission factors is complete, the word embeddings for the emission factors may be created (e.g., generated) by using for example the language model 150 (which may be trained using different materials to provide a vector representation, for example) or other type of machine learning model such as a neutral network and/or the like. A word embedding is generated for the material being queried (e.g., an embedding for “butter”) that is then used to search for an emission factor that is a best match given the embedding. The one or more best matches may then be returned as a search query response from the emission factor service and presented to the user at the client device 110.

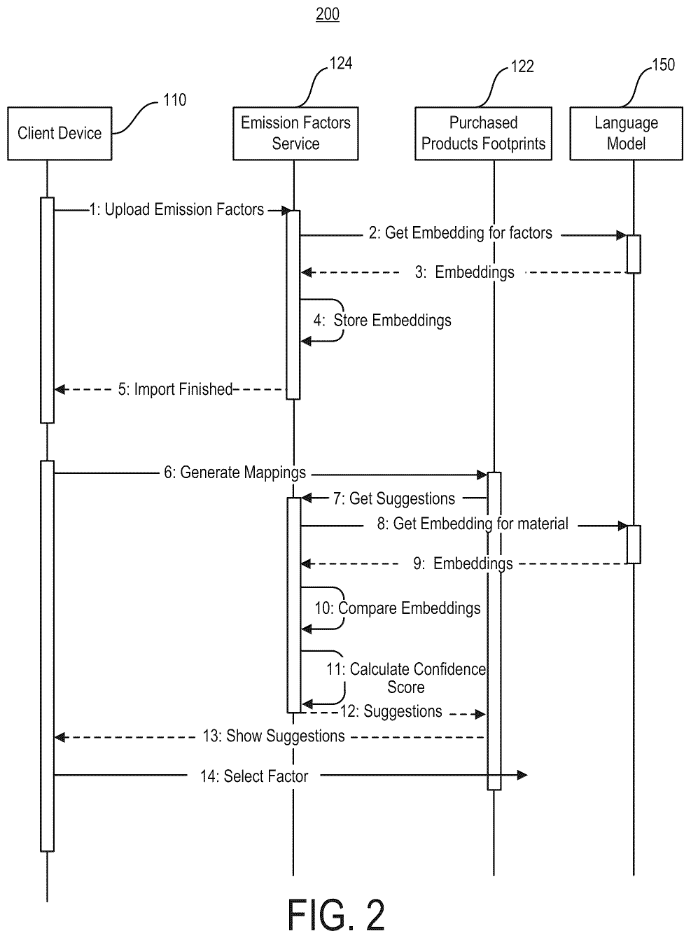

FIG. 2 depicts an example of a process 200 for obtaining emission factors for materials, in accordance with some embodiments. Depicted at FIG. 2 are the client device 110 (at which a user can access the system 100 at the client device 110), the EF 124, the PPF 122, and the language model 150.

At 1, the client device 110 may request emission factors to be uploaded. For example, the client device may request that one or more emission factors be uploaded from for example a third-party database. The emission factors may be stored in the emission factors store 125B. To illustrate further, the client device may request emission factors for butter, milk, eggs, cream, and/or the like.

At 2, the EF 124 may get embeddings for the emission factors from the language model 150. For the emission factor for “butter” for example, this string may be provided to the language model, which responds, at 3, with an embedding for butter. Alternatively, or additionally, the term “butter” may be associated with additional attributes (also referred to as terms), such as commodity code (e.g., 02412), product group (e.g., diary), supplier (e.g., Creamy Delights), and country or region (e.g., Canada). One or more of these additional attributes may be added to the string “butter” to form an augmented string (e.g., butter, 02412, diary, Creamy Delights, and Canada). This augmented string is provided, at 2, to the language model 150 (LM), which returns, at 3, the embedding for the augmented string. At 4, the embedding may be stored at the embedding store 125A. Referring to the prior example, the embedding for butter may be stored in the embedding store 125A and mapped to a corresponding emission factor. To illustrate further, the embedding for “butter, 02412, diary, Creamy Delights, and Canada” may be stored in the embedding stored 125A with a key mapping to an emission factor (which was obtained at 1). When the embeddings are determined for the emission factors of interest (which in this example is butter, milk, eggs, cream, and/or the like), the import of the emission factors may be considered complete at 5. At this stage, a plurality of materials may have embeddings mapped to corresponding emission factors stored to enable a semantic search via the semantic search API 199.

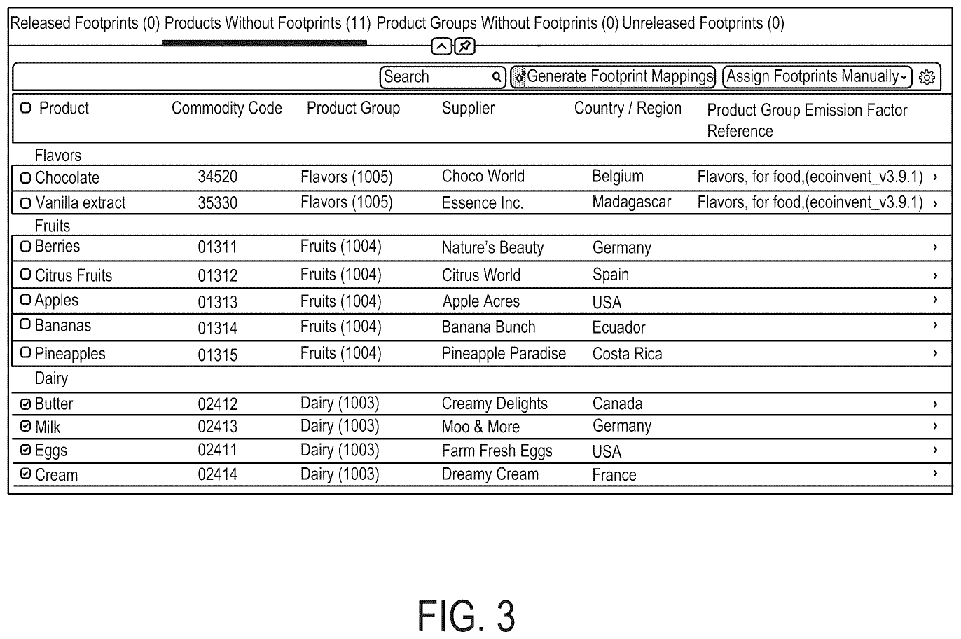

At 6, the client device 110 may request (or cause a request of) the PPF 122 to generate mappings. For example, a user at client device may view a user interface 300 that is depicted at FIG. 3. In the example of FIG. 3, there are a list of materials (e.g., “products” the first column) that do not have a corresponding emission factor. In this example, a selection of 4 products (as shown by the check mark at butter, milk, eggs, cream) is made. And these four products are the materials/products for which intelligent mappings are generated for the emission factors. For example, the selection at the client device 110 cause the PPF 122 to generate mappings for these products. FIG. 3 also shows that each product has additional attributes (e.g., terms or information) associated with the product. For example, butter has a commodity code (e.g., 02412), a product group (e.g., diary), a supplier (e.g., Creamy Delights), and a country/region (e.g., Canada). One or more of these may be needed to identify the proper emission factor for butter. To illustrate further, there may be a first emission factor for butter from Canada and a second emission factor for butter from Ireland. Similarly, the term “butter” may also be associated with an engine fluid and a cosmetic product, so the commodity code or product group may help clearly identify the material of interest.

Referring again to FIG. 2, to generate the mappings, the PPF 122 may access, at 7, the EF 124 to obtain suggestions for the emission factors. To illustrate, the PPF may want suggested emission factors for “butter, commodity code (02412), product group (diary), a supplier (Creamy Delights), and country/region (Canada), for “milk, commodity code (02413), product group (diary), supplier (Moe and more), and country/region (Germany),” and so forth. To that end, the EF may get (at 8) embeddings using the language model 150. For example, the EF may get embedding for:
butter, 02412, diary, Creamy Delights, Canada,
milk, 02413, diary, Moe and more, and Germany;
eggs . . . ; and
cream

At 9, the language model 150 responds to the EF 124 with the embeddings. For example, the response may be as follows:
butter, 02412, diary, Creamy Delights, Canada with an embedding equal to 1001.1;
milk, 02413, diary, Moe and more, and Germany with an embedding equal to 1005.4;
eggs . . . ; and
cream

At this stage of the process, the EF 124 has a list of 4 products, such as the materials butter, milk, eggs, and cream, and the embeddings for each of these materials. Using the embeddings, a semantic search may be performed (e.g., via semantic search API 199) to identify similar embeddings in embedding store 125A, which have a mapped emission factor (which is stored at emission factors store 125B). To that end, the EF compares the embeddings for butter with the embedding stored in the embedding store 125A. The comparison is performed in the vector space defined by the embeddings, so if the embedding for butter is within a threshold distance (e.g., a cosine similarity score) of a stored embedding in the embedding store 125A, that stored embedding may be considered a match for butter. The matching emission factor (which is mapped and stored at emission factors store 125B) is considered the emission factor for butter, for example.

At 11, the EF 124 determines one or more scores, such as confidence scores, for the embeddings, as noted. The confidence score may represent a distance measure or a cosine similarity value between embeddings, such as between the embeddings for “butter” with one or more embeddings stored in the embedding store 125A. This confidence score may thus indicate the “closeness” and thus similarity between the embeddings and provide a confidence score for any matches found in the embeddings store. To illustrate further, the embeddings for “butter, 02412, diary, Creamy Delights, Canada”, “butter, 02412, diary, Creamy Delights, Ireland”, and “butter, 02412, diary, Creamy Delights, Wisconsin” will be closer in vector space, when compared to other word embeddings, such as the embeddings for eggs, cream, etc.

At 12, the EF 124 may provide to the PPF 122 one or more suggestions for the emission factors. Referring to the prior example, the emission factor (which was mapped to the matching embedding stored in the embedding store) may be provided to the PPF 122 as a suggested emission factor for “butter” (or “butter, 02412, diary, Creamy Delights, Canada”). In response, the PPF 122 may provide, at 13, the suggested emission factor to the client device 110. For example, the PPF may cause a user interface to present the “butter” with a corresponding emission factor (as well as confidence score). In some instances, the user at client device 110 may select the suggested emission factor (e.g., so that it can be used in a GHG calculation), and this selection may be signaled to the PPF 122 so the selected emission factor for “butter” (or “butter, 02412, diary, Creamy Delights, Canada”) can be stored as a mapping at the PPF.

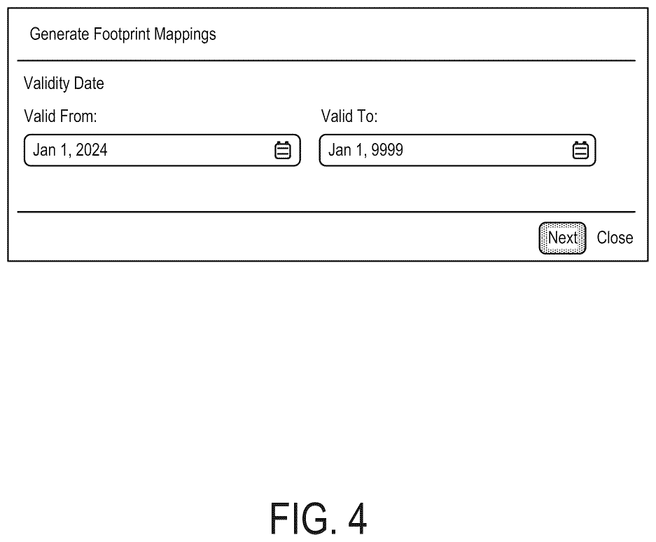

FIG. 4 depicts another example of a user interface. The user interface may be used to provide at the client device 110 a validity range for the emission factors being obtained for the products of FIG. 3. For example, the emission factor for butter may be obtained from a third-party database and the version of that emission factor data may change over time. As such, the client device may be used to specify a validity range for the emission factor. At FIG. 4, the validity period is any emission factor that is dated after Jan. 1, 2024, so emission factors prior to that date would not be returned by the PPF 122.

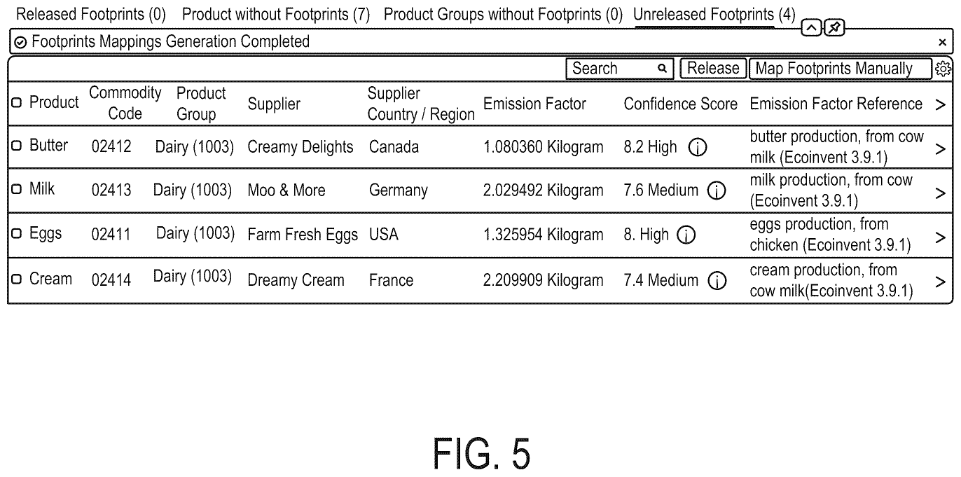

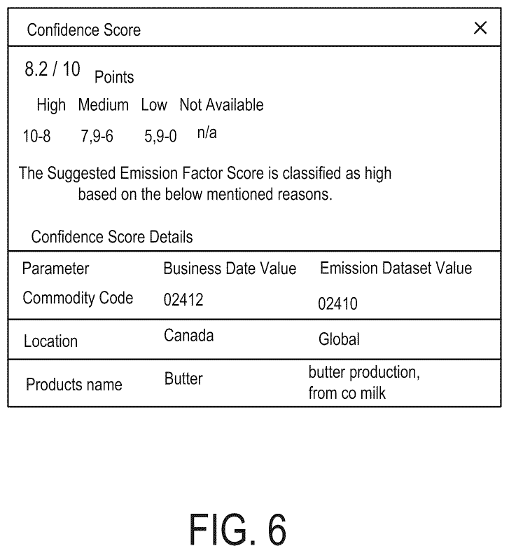

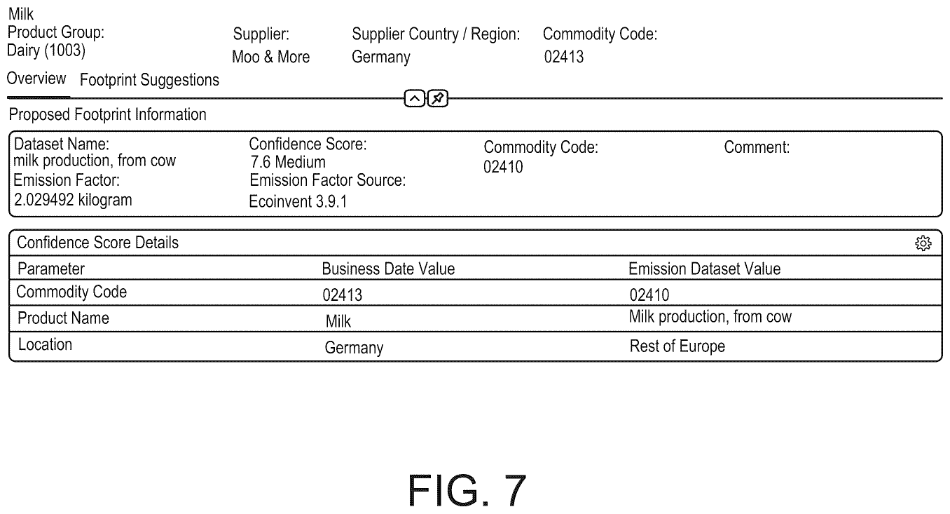

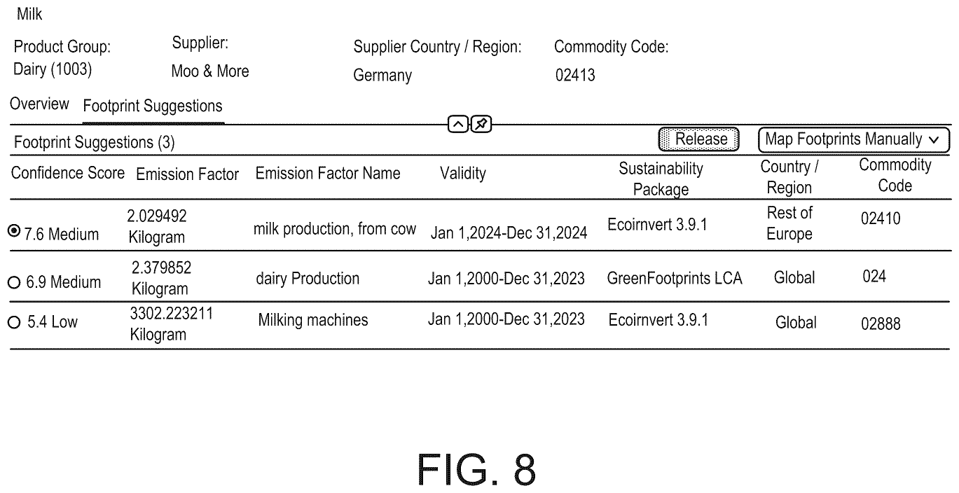

FIG. 5 depicts another example of a user interface. The user interface of FIG. 5 shows an example of the emission factors returned at 13 to the client device 110 and presented via the user interface. For each product, such as butter, milk, etc., the emission factor is provided along with a confidence score and an emission factor reference (which identifies a third-party database from which the emission factor was obtained). If any of the confidence scores is selected, the user interface of FIG. 6 may be presented at client device 110 to show additional details regarding the confidence score (e.g., what is considered high, medium, or low confidence). FIGS. 7 and 8 show drill downs with additional details for the emission factor (FIG. 7) and the material/product and corresponding attributes (FIG. 8).

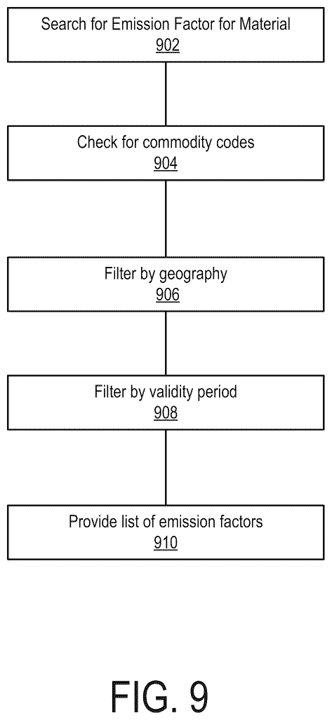

FIG. 9 depicts an example process for searching for emission factors, in accordance with some embodiments. When the EF 24 receives a semantic search request for emission factor(s) suggestions via the semantic search API 199, the EF may find an emission factor for a given material at 902. For example, the semantic search request may be for the material “butter”. As noted, the search is performed based on the embedding for “butter”. The embedding for “butter” may be augmented with additional information (also referred to as “attributes”) that further specifies the material. For example, the embedding for “butter” may be augmented with additional embeddings for one or more of the following: commodity code (e.g., an embedding for commodity code 02412), product group (e.g., an embedding for material type, such as diary), a supplier (e.g., an embedding for a source or manufacture of the material, such as Creamy Delights), and country/region (e.g., an embedding for a source of the material, such as Canada), and/or other information that can further specific the material.

At 902, a search is initiated based at least one the embedding which may include additional embeddings for the additional information that specifies the material of interest. For example, the EF 124 may perform a semantic search of the embedding store 125A for the embedding for “butter” which may further include the embeddings for attributes, such as “commodity code 02412, product diary, source Creamy Delights, and/or country Canada.”

At 904, the EF 124 may limit the search of the embedding store 125A by checking the stored embeddings (which are stored in the embedding store 125A and thus mapped to a corresponding emission factor) that have a same or similar commodity code. For example, the embedding for “butter” (or the embeddings for “butter” “commodity code 02412, product diary, source Creamy Delights, and/or country Canada”) are only compared to those stored embedding having the same or similar commodity code. In this way, the material being searched is only compared (see, e.g., compare embeddings at 10 at FIG. 2) to the stored embeddings (of the embeddings store 125A) that have the same commodity code of “02412”. In this way, the search time can be reduced by reducing the stored embeddings being searched.

At 906, the stored embeddings that are compared and match the embedding being searched may be filtered by geography. For example, if the embedding for “butter” finds a group of stored embeddings during the compare at 10 of FIG. 2, the EF 124 may filter the results based on geography. For example, if the embedding for “butter” results in 5 matching stored embeddings, the EF may filter the result set so that only the results from Canada remain. If, however, the result set is empty (which in this example, none of the stored embeddings are from Canada), the EF may provide the result set in an unfiltered form and/or use a default geography (e.g., Europe) to filter the results.

At 908, the stored embeddings (which are compared and match the embedding being searched) may be filtered based on validity period. As noted above with respect to FIG. 4, a validity range for the emission factors being obtained for the material may be specified. For example, if the embedding for “butter” finds a group of stored embeddings during the compare at 10 of FIG. 2, the EF 124 may filter the results such that only the results with emission factors after Jan. 1, 2024 (see, e.g., FIG. 4) are returned as suggestions to the client device 110. If, however, the result set is empty (which in this example, none of the stored embeddings have emission factors that were validated after Jan. 1, 2024), the EF may provide suggested emission factors in an unfiltered form (so emission factors that are “outdated” as they are before Jan. 1, 2024).

At 910, the final list of emission factors may then be provided to the PPF 122. For example, after the noted filtering, the remaining stored emission factors may then be provided by the EF 124 to the PPF 122 (see., e.g., 12 at FIG. 2).

In some implementations, the embedding store 125A is stored in a vector database (which refers to a database configured to handle the vectors associated with embeddings), although other types of databases and/or stores may be used in other embodiments.

In some embodiments, the search of the embedding store 125A for one or more matchings materials may be based on one or more search attributes, each of which may be represented by a word embedding. In other words, multiple material attributes may be used to suggest a match in the stored word embeddings and thus the corresponding emission factor. Table 1 below lists examples of some of the attributes. Likewise, a variety of attributes may be used for the stored embeddings which are mapped to emission factors. Table 2 below shows examples of some of the attributes for emission factors.

TABLE 1

| Attribute | Relevance |
|---|---|
| Material Name | Name of the material, natural language |
| Material Description | Description of the material, natural language |
| Product Group Name | Additional information, natural language |
| Commodity Code | Code of a product classification system, |
| | revealing information about specific product |
| | and helping to narrow the search |
| Country of Origin | Country/Region code the product was |
| | produced |
| Validity Period | Temporal information, important since factors |
| | which are not valid for the time frame should |
| | be used |
| Raw Material | Information about the raw material used for |
| | the product, helpful for materials with low |
| | processing amount (for example steel beams), |
| | available as code or natural language |
| Production Technology | Information about how the product was |
| | created, natural language |

TABLE 2

| Attribute | Relevance |
|---|---|
| Name | Name of the material for the emission factor, |
| | natural language |
| Description | Description of the emission factor, usually |
| | includes information about production |
| | technology and usage, natural language |
| Commodity Code | Code of a product classification system, |
| | revealing information about specific product |
| | and helping to narrow the search |
| Country | Country/Region code the emission factor was |
| | created for |
| Validity Period | Temporal information, indicating for which |
| | period the emission factor should be used |

For both entities, the attributes containing natural language are used for the documents to create the embeddings to maximize the useable information. This includes the attributes name and description for both entities. On the material, additional information is available: product group name and production technology.

The attribute commodity code is available on both entities. Since this is a technical code, pattern matching techniques can be used. Commodity codes are usually structured hierarchically, this means in the case that there is no direct match based on the commodity code of the material, it can be search if there is a factor for the next level of the hierarchy. The information about the raw material can be either a technical code or written using natural language. In the case of a technical code, it is evaluated using pattern matching. Since this information is only available on the material side, the resulting natural language is also used for the document generating the embedding.

The country of origin is a technical code, which can be used for direct matching. In the intelligent mapping process, a hierarchy of country/region is defined that allows for fallbacks. For example, Europe as a fallback for Germany. This is enabled by the emission factor databases which usually define factors for encompassing regions.

Referring again to FIG. 2 at 11, a confidence score may be determined. Based on the attributes of a material (e.g., the embeddings for the attributes) noted above with respect to Tables 1 and 2, the system 100 may determine confidence scores to rank the results and/or provide a user with an indication of why an emission factor was suggested for a given material. The confidence score may be determined as a distance metric, a similarity metric, and/or the like. For example, a cosine similarity metrics may be used to measure the similarity (e.g., as a similarity between two vectors of an inner product space).

In some embodiments, the confidence score is determined based on a combination, such as the sum, of the cosine similarity score, a geography score, a commodity code score, and/or a temporal score. For example, the cosine similarity score may be determined, as noted, between an embedding being searched and the stored embedding in the embedding store 125A. Alternatively, or additionally, the cosine similarity score may be normalized before being combined with the geography score, the commodity code score, and/or the temporal score.

The geography score may be determined as follows. If the emission factor mapped to the material is available for the country or region attribute of the material (e.g., Germany or EU for the butter example), the geography score is high (e.g., a value of 10 on a scale of 1-10). But if the emission factor is not available for the country or region attribute of the material but a similar country's emission factor is available (e.g., Spain's emission factor is available for butter, but not Germany's emission factor), the geography score may be moderate (e.g., a value of 5 on a scale of 1-10). If a default emission score is used because a matching country or region is not available, the geography score is low (e.g., a value of 1 on a scale of 1-10). Alternatively, or additionally, the geography score may be normalized before being combined with other scores.

The commodity code score may be determined based on the degree of match between the commodity code for the embedding being searched and the stored embedding in the embedding store. For example, if the CPC code for the product being searched is 5312 and the emission factor corresponding to the stored embedding in the embedding store 125A is 531, the degree of match may be 7.5 (on a scale of 1-10, where ¾ of the CPC codes match). If the CPC code for the product being searched is 5312 and the emission factor corresponding to the stored embedding in the embedding store 125A is 511, the degree of match may be 2.5 (on a scale of 1-10, where ¼ of the CPC codes match). Alternatively, or additionally, the commodity score may be normalized before being combined with other scores.

The temporal score may be determined based on the validity period for the emission factor. For example, if the emission factor has a validity period of Jan. 1, 2024 to Jan. 31, 2024 for an emission factor query with a March 2024 validity period (e.g., the validity period requested by the client device 110), the temporal score may be a value of 2 on a scale of 0-2. If the emission factor being has a validity period of Jan. 1, 2022 to Jan. 31, 2022 for an emission factor query with a March 2024 validity period (e.g., the validity period requested by the client device 110), there is no overlap in the validity of the emission factor data, so the temporal score may be a value of 0 on a scale of 0-2. And if the emission factor being used has a validity period of Jan. 1, 2022 to Jan. 31, 2024, the temporal score may be a value of 1 on a scale of 0-2 as there is only a partial overlap in the validity periods. Alternatively, or additionally, the temporal score may be normalized before being combined with other scores.

If the validity period of the mapping is within a validity timeframe of the emission factor, the validity period may affect the score positively. On the other hand, if the validity period is outside of the timeframe, the validity period will have a negative impact. The user (at client device 11) may also able to assign weights to the different attributes so as to provide the ability to customize the intelligent search for emission factors to certain requirements and/or the quality of the available data. For some of the attributes (e.g., country/region, commodity code, etc.), the position in a hierarchy may be used. The hierarchy will be traversed to check for a match. If there is no direct match, the search will be conducted using a higher level of the hierarchy. For example, if the country of origin is Spain, the mapping algorithm may first search for emission factors from Spain. If there are no emission factors that match, the mapping algorithm searches for factors from Europe. And if there are no emission factors that match in Europe, the mapping algorithm check for global emission factors. While direct matches positively influence the confidence score, matches in a higher level can negatively affect the score.

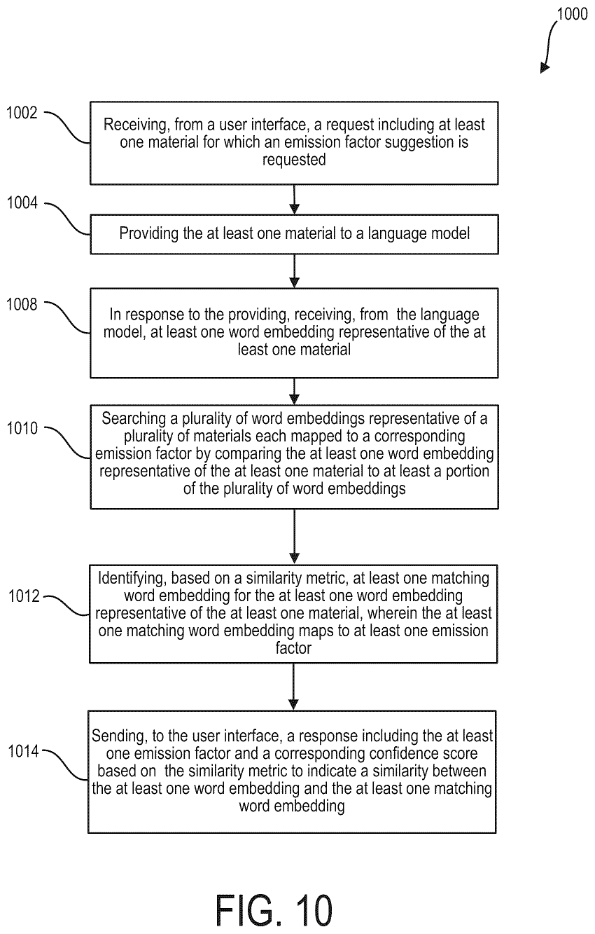

FIG. 10 depicts an example of a process 1000 for generating intelligent emission factor suggestions, in accordance with some embodiments.

At 1002, a request may be received from a user interface, and this request may include at least one material for which an emission factor suggestion is requested. For example, the user interface of FIG. 3 may be presented at the client device 110, such that a selection of at least one material (e.g., butter, milk, etc.) is made to obtain an emission factor suggestion. This selection is sent by the client device 110 and received by the SFM 120.

At 1004, the at least one material may be provided to a language model. For example, in response to the request, the EF 124 may get embeddings for the at least one material (e.g., “butter”, etc.) from the language model 150. Embedding for additional attributes may also be obtained, such as one or more attributes a commodity code, a product group, a supplier, a country, and/or a region. At 1008, in response to the providing, at least one word embedding representative of the at least one material may be received from the language model. For example, language model 150 may return an embedding for the at least one material (e.g., “butter”). Alternatively, or additionally, the embedding may include the one or more attributes (e.g., CPC code, country, etc.). Alternatively, or additionally, another embedding may be provided for the one or more attributes.

At 1010, a plurality of word embeddings representative of a plurality of materials may be searched, wherein the plurality of materials are each mapped to a corresponding emission factor, and wherein the searching includes comparing the at least one word embedding representative of the at least one material to at least a portion of the plurality of word embeddings. As noted above, the embedding for “butter” may be used to search the embedding store 125A for matching word embeddings (which were previously mapped to emission factors).

At 1012, the process may also include identifying, based on a similarity metric, at least one matching word embedding for the at least one word embedding representative of the at least one material, wherein the at least one matching word embedding maps to at least one emission factor. For example, based on a similarity metric, a matching word embedding (which is in the embedding store) may be identifies for the at least one word embedding representative of the at least one material (e.g., butter).

At 1014, the process may include sending, to the user interface, a response including the at least one emission factor and a corresponding confidence score based on the similarity metric to indicate a similarity between the at least one word embedding and the at least one matching word embedding. The matching word embedding and emission factor may be sent by the SFM 120 to the client device 110, where it can be presented as a user interface (see, e.g., FIG. 5).

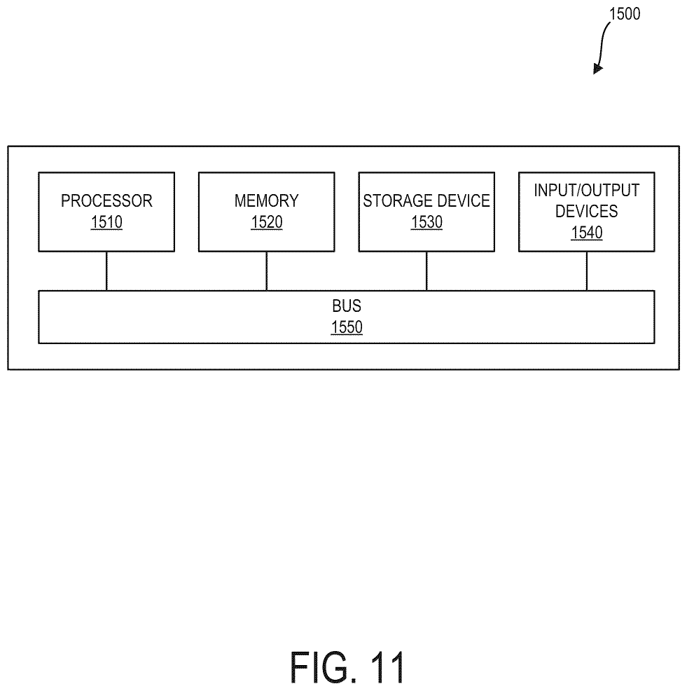

FIG. 11 depicts a block diagram illustrating a computing system 1500, in accordance with some example embodiments. The computing system 1500 can be used to implement any of the components noted with respect to FIG. 2 and/or the cause or provide any of the processes discloses herein. As shown in FIG. 11, computing system 1500 can include a processor 1510, a memory 1520, a storage device 1530, and an input/output device 1540. The processor 1510, the memory 1520, the storage device 1530, and the input/output device 1540 can be interconnected via a system bus 1550. The processor 1510 is capable of processing instructions for execution within the computing system 1500. In some implementations of the current subject matter, the processor 1510 can be a single-threaded processor. Alternately, the processor 1510 can be a multi-threaded processor. The processor 1510 is capable of processing instructions stored in the memory 1520 and/or on the storage device 1530 to display graphical information for a user interface provided via the input/output device 1540. The memory 1520 is a computer readable medium such as volatile or non-volatile that stores information within the computing system 1500. The memory 1520 can store data structures representing configuration object databases, for example. The storage device 1530 is capable of providing persistent storage for the computing system 1500. The storage device 1530 can be a floppy disk device, a hard disk device, an optical disk device, or a tape device, or other suitable persistent storage means. The input/output device 1540 provides input/output operations for the computing system 1500. In some implementations of the current subject matter, the input/output device 1540 includes a keyboard and/or pointing device. In various implementations, the input/output device 540 includes a display unit for displaying graphical user interfaces. According to some implementations of the current subject matter, the input/output device 1540 can provide input/output operations for a network device. For example, the input/output device 1540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory including program code which when executed by the at least one processor causes operations comprising:
   receiving, from a user interface, a request including at least one material for which an emission factor suggestion is requested;
   providing the at least one material to a language model;
   in response to the providing, receiving, from the language model, at least one word embedding representative of the at least one material;
   searching a plurality of word embeddings representative of a plurality of materials each mapped to a corresponding emission factor, the searching comprising comparing the at least one word embedding representative of the at least one material to at least a portion of the plurality of word embeddings;
   identifying, based on a similarity metric, at least one matching word embedding for the at least one word embedding representative of the at least one material, wherein the at least one matching word embedding maps to at least one emission factor; and
   sending, to the user interface, a response including the at least one emission factor and a corresponding confidence score based on the similarity metric to indicate a similarity between the at least one word embedding and the at least one matching word embedding.

Example 2: The system of Example 1, wherein the request may be received with one or more additional attributes associated with the at least one material.

Example 3: The system of any of Examples 1-2, wherein the additional attributes comprise a commodity code, a product group, a supplier, a country, and/or a region.

Example 4: The system of any of Examples 1-3, wherein the providing further comprises providing the at least one material and the one or more additional attributes to the language model.

Example 5: The system of any of Examples 1-4, wherein in response to the providing, the receiving, from the language model, further comprises receiving at least one word embedding representative of the at least one material and the one or more additional attributes.

Example 6: The system of any of Examples 1-5, wherein the comparing comprises comparing the at least one word embedding representative of the at least one material and the one or more additional attributes to the plurality of word embeddings.

Example 7: The system of any of Examples 1-6, wherein the searching of the plurality of word embeddings further comprises limiting the searching to only the plurality of word embeddings having a same commodity code as the at least one material.

Example 8: The system of any of Examples 1-7, wherein the identifying further comprises filtering the at least one matching word embedding based on geography and/or a validity period.

Example 9: The system of any of Examples 1-8, wherein the similarity metric comprises a cosine similarity metric determined between the at least one word embedding representative of the at least one material and the plurality of word embeddings.

Example 10: The system of any of Examples 1-9, wherein the searching comprises searching a vector database containing the plurality of word embeddings representative of the plurality of materials.

Example 11: The system of any of Examples 1-10, wherein the at least one emission factor is stored such that the at least one emission factor is mapped to the at least one matching word embedding.

Example 12: The system of any of Examples 1-11, wherein the confidence score comprises a sum of a cosine similarity score, a geography score, a commodity code score, and a temporal score.

Example 13: A method comprising:
receiving, from a user interface, a request including at least one material for which an emission factor suggestion is requested;
providing the at least one material to a language model;
in response to the providing, receiving, from the language model, at least one word embedding representative of the at least one material;
searching a plurality of word embeddings representative of a plurality of materials each mapped to a corresponding emission factor, the searching comprising comparing the at least one word embedding representative of the at least one material to at least a portion of the plurality of word embeddings;
identifying, based on a similarity metric, at least one matching word embedding for the at least one word embedding representative of the at least one material, wherein the at least one matching word embedding maps to at least one emission factor; and
sending, to the user interface, a response including the at least one emission factor and a corresponding confidence score based on the similarity metric to indicate a similarity between the at least one word embedding and the at least one matching word embedding.

Example 14: The method of Example 13, wherein the request may be received with one or more additional attributes associated with the at least one material.

Example 15: The method of any of Example 13-14, wherein the additional attributes comprise a commodity code, a product group, a supplier, a country, and/or a region.

Example 16: The method of any of Example 13-15, wherein the providing further comprises providing the at least one material and the one or more additional attributes to the language model.

Example 17: The method of any of Example 13-16, wherein in response to the providing, the receiving, from the language model, further comprises receiving at least one word embedding representative of the at least one material and the one or more additional attributes.

Example 18: The method of any of Example 13-17, wherein the comparing comprises comparing the at least one word embedding representative of the at least one material and the one or more additional attributes to the plurality of word embeddings.

Example 19: The method of any of Example 13-18, wherein the searching of the plurality of word embeddings further comprises limiting the searching to only the plurality of word embeddings having a same commodity code as the at least one material.

Example 20: A non-transitory computer readable store medium including executable code which when executed by at least one processor causes operations comprising:
receiving, from a user interface, a request including at least one material for which an emission factor suggestion is requested;
providing the at least one material to a language model;
in response to the providing, receiving, from the language model, at least one word embedding representative of the at least one material;
searching a plurality of word embeddings representative of a plurality of materials each mapped to a corresponding emission factor, the searching comprising comparing the at least one word embedding representative of the at least one material to at least a portion of the plurality of word embeddings;
identifying, based on a similarity metric, at least one matching word embedding for the at least one word embedding representative of the at least one material, wherein the at least one matching word embedding maps to at least one emission factor; and
sending, to the user interface, a response including the at least one emission factor and a corresponding confidence score based on the similarity metric to indicate a similarity between the at least one word embedding and the at least one matching word embedding.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor causes operations comprising:
receiving, from a user interface, a request including at least one material for which an emission factor suggestion is requested;
providing the at least one material to a language model;
in response to the providing, receiving, from the language model, at least one word embedding representative of the at least one material;
searching a plurality of word embeddings representative of a plurality of materials each mapped to a corresponding emission factor, the searching comprising comparing the at least one word embedding representative of the at least one material to at least a portion of the plurality of word embeddings;
identifying, based on a similarity metric, at least one matching word embedding for the at least one word embedding representative of the at least one material, wherein the at least one matching word embedding maps to at least one emission factor; and
sending, to the user interface, a response including the at least one emission factor and a corresponding confidence score based on the similarity metric to indicate a similarity between the at least one word embedding and the at least one matching word embedding.

2. The system of claim 1, wherein the request may be received with one or more additional attributes associated with the at least one material.

3. The system of claim 2, wherein the additional attributes comprise a commodity code, a product group, a supplier, a country, and/or a region.

4. The system of claim 2, wherein the providing further comprises providing the at least one material and the one or more additional attributes to the language model.

5. The system of claim 4, wherein in response to the providing, the receiving, from the language model, further comprises receiving at least one word embedding representative of the at least one material and the one or more additional attributes.

6. The system of claim 5, wherein the comparing comprises comparing the at least one word embedding representative of the at least one material and the one or more additional attributes to the plurality of word embeddings.

7. The system of claim 1, wherein the searching of the plurality of word embeddings further comprises limiting the searching to only the plurality of word embeddings having a same commodity code as the at least one material.

8. The system of claim 1, wherein the identifying further comprises filtering the at least one matching word embedding based on geography and/or a validity period.

9. The system of claim 1, wherein the similarity metric comprises a cosine similarity metric determined between the at least one word embedding representative of the at least one material and the plurality of word embeddings.

10. The system of claim 1, wherein the searching comprises searching a vector database containing the plurality of word embeddings representative of the plurality of materials.

11. The system of claim 1, wherein the at least one emission factor is stored such that the at least one emission factor is mapped to the at least one matching word embedding.

12. The system of claim 1, wherein the confidence score comprises a sum of a cosine similarity score, a geography score, a commodity code score, and a temporal score.

13. A method comprising:
receiving, from a user interface, a request including at least one material for which an emission factor suggestion is requested;
providing the at least one material to a language model;
in response to the providing, receiving, from the language model, at least one word embedding representative of the at least one material;
searching a plurality of word embeddings representative of a plurality of materials each mapped to a corresponding emission factor, the searching comprising comparing the at least one word embedding representative of the at least one material to at least a portion of the plurality of word embeddings;
identifying, based on a similarity metric, at least one matching word embedding for the at least one word embedding representative of the at least one material, wherein the at least one matching word embedding maps to at least one emission factor; and
sending, to the user interface, a response including the at least one emission factor and a corresponding confidence score based on the similarity metric to indicate a similarity between the at least one word embedding and the at least one matching word embedding.

14. The method of claim 13, wherein the request may be received with one or more additional attributes associated with the at least one material.

15. The method of claim 14, wherein the additional attributes comprise a commodity code, a product group, a supplier, a country, and/or a region.

16. The method of claim 14, wherein the providing further comprises providing the at least one material and the one or more additional attributes to the language model.

17. The method of claim 16, wherein in response to the providing, the receiving, from the language model, further comprises receiving at least one word embedding representative of the at least one material and the one or more additional attributes.

18. The method of claim 17, wherein the comparing comprises comparing the at least one word embedding representative of the at least one material and the one or more additional attributes to the plurality of word embeddings.

19. The method of claim 13, wherein the searching of the plurality of word embeddings further comprises limiting the searching to only the plurality of word embeddings having a same commodity code as the at least one material.

20. A non-transitory computer readable store medium including executable code which when executed by at least one processor causes operations comprising:
receiving, from a user interface, a request including at least one material for which an emission factor suggestion is requested;
providing the at least one material to a language model;
in response to the providing, receiving, from the language model, at least one word embedding representative of the at least one material;
searching a plurality of word embeddings representative of a plurality of materials each mapped to a corresponding emission factor, the searching comprising comparing the at least one word embedding representative of the at least one material to at least a portion of the plurality of word embeddings;
identifying, based on a similarity metric, at least one matching word embedding for the at least one word embedding representative of the at least one material, wherein the at least one matching word embedding maps to at least one emission factor; and
sending, to the user interface, a response including the at least one emission factor and a corresponding confidence score based on the similarity metric to indicate a similarity between the at least one word embedding and the at least one matching word embedding.
